(19) United States
(12) Patent Application Publication
(10) Pub. No.: US 2005/0283529 A1
(43) Pub. Date: Dec. 22, 2005

(54) Method and apparatus for providing redundant connection services

(76) Inventors: Wan-Yen Hsu, Cuppertino, CA (US); Isaac Wong, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/874,665

(22) Filed: Jun. 22, 2004

(51) Int. Cl. G06F 15/173; G06F 15/16

(52) U.S. Cl. 709/224; 709/227

(57) ABSTRACT

A connection from a client to a primary server is monitored and state information pertaining to a protocol stack used in the primary server is conveyed to a standby server. When the primary server becomes unhealthy, a crossover message is sent by the standby server to a client according to the conveyed state information.

### BACKGROUND

Modernly, computer systems are typically communicatively associated with each other for the purposes of sharing data. In order to enable one computer to share data with another, each computer is typically connected to the other by means of a computer network. For example, the Internet is a wide-area computer network to which plethoras of computing platforms are connected. The physical connectivity of one computer to another is only one part of an extremely complex structure where one computer is able to access data provided by another computer. The access of data stored on one computer by another computer also entails various paradigms that govern the sharing of data. A common paradigm employed for sharing data stored on one computer with other computers attached to a network is known as the “client-server” model. The client-server model defines one computer attached to a network as a server capable of providing information in response to a request received from a client.

In order to enable communications between a client and the server, each computer must adhere to a common communications protocol. A communications protocol defines the interaction between active processes executing on each computer. For example, a server process executing on one computer system typically adheres to a common communications protocol so as to enable communications with a client process executing on another computer system. One example of a communications protocol that is currently in wide-spread use is the Transmission Control Protocol/Internet Protocol (TCP/IP).

Typically, a communications protocol is implemented in a specialized functional module called a “protocol stack”. A protocol stack typically includes various instruction sequences that can be executed by a processor in a first computer. When a processor executes the protocol stack, it engages in a communications session with a second computer. Typically, a processor in the second computer also executes a protocol stack enabling the processor in the second computer to engage in a communications session with the first computer. It can be appreciated that the protocol stacks in each computer must be fashioned in accordance with a common protocol definition.

Many different protocol definitions currently exist and for each of these protocol definitions there are typically one or more implementations of a “protocol stack”. The term protocol stack is derived from the layered structure a typical protocol definition describes. For example, most protocol definitions define communication services at varying levels of sophistication. At the most primitive layer, a protocol definition typically defines a physical medium that actually carries the data. The more primitive communication services included in a protocol definition are usually used to support higher level services, such as connection layer services. Even higher levels of service, e.g. guaranteed delivery of data, are often described in a protocol definition. Each of these layers of service typically corresponds to a layer in the “stack” of instruction sequence modules that are included in a protocol stack.

According to many of these varied protocol definitions, a client-server paradigm is supported through the use of connections between two processes. For example, a first process executing in one computer generally exploits a protocol stack in order to establish a connection with a second process. Typically, the second process executes in a different computer. However, a typical protocol stack does not differentiate the execution venue of a process. Accordingly, a protocol stack can be used to establish a connection between two processes executing in the same computer.

As a protocol stack operates, it maintains information about its internal state and further maintains information pertaining to communications connections it is supporting. This type of information is typically included in a protocol stack state variable table. The protocol stack state variable table is typically stored in a computer readable medium accessible by a processor that is executing the protocol stack. When a communications connection is established, the protocol stack, when executed by a processor, will cause the processor to track the state of a connection using several sets of state variables, wherein each set of state variables corresponds to a particular layer in the protocol stack.

Computer systems are just as prone to error and failure as are other man-made apparatus. In order to support the demand for high availability, computer systems that operate as a server in a client-server system are replicated in a unit known as a cluster. Within such a cluster, one computer is typically designated as a primary server. The remaining one or more computers in the cluster are designated as standby servers. In normal operation, a client process executing in a client computer will seek to establish a connection with a server process executing in the primary server. Once the communications connection is established, a protocol stack executing in the primary server will track the state of the connection. A corresponding protocol stack executing in the client computer will also track the state of the connection.

When a primary server in a high-availability cluster fails, or is otherwise unable to maintain its role as a server, server functions are migrated to one of the one or more standby servers included in the cluster. From the perspective of a client process executing in a client computer, the only indication that the primary server has failed is that the connection maintained by the protocol stack executing in the primary server becomes non-responsive. Ideally, when a client computer determines that a connection has been severed, it should attempt to re-establish the connection. When the connection is re-established, the client is usually oblivious to the fact that a standby server in the cluster has assumed the server role in the client-server relationship. Accordingly, the transition from the primary server to a standby server is substantially transparent to the client computer.

As can be appreciated, the protocol stack in the primary server computer and the protocol stack in the client computer are complex computer programs, each designed to engage in a communications session with its counterpart. Because of the complexity involved in tracking the state of a connection, both in the server and in the client computers, there may be a significant latency between the time when a primary server actually fails and when a client computer, through diligent tracking of the state of a connection, determines that the connection between a client process and a server process has been severed. It is only when a client computer can determine that a connection has been severed that an essentially seamless transition to a standby server can be made. As such, an unacceptably long period of time may expire before the client computer even attempts to re-establish a connection with a standby server. This long delay can result in user frustration and defeats the graceful migration of a server role from a primary to a standby computer.

### SUMMARY

A method and apparatus for providing redundant connection services comprising the establishment of a connection from a client to a primary server and the conveyance of state information pertaining to a protocol stack used in the primary server. The health of the primary server is monitored. When the primary server becomes unhealthy, a crossover message is sent to a client according to the conveyed state information.

### BRIEF DESCRIPTION OF THE DRAWINGS

Several alternative embodiments will hereinafter be described in conjunction with the appended drawings and figures, wherein like numerals denote like elements, and in which:

FIG. 1 is a flow diagram that depicts one example method for providing redundant connection services;

FIG. 2 is a flow diagram that depicts an alternative illustrative method for conveying connection state information;

FIG. 3 is a flow diagram that depicts several other alternative methods for conveying connection state information;

FIG. 4 is a flow diagram that depicts several illustrative example methods for dispatching a crossover message;

FIG. 5 is a flow diagram that illustrates one alternative method for including a sequence number in a crossover message;

FIG. 6 is a pictorial illustration of a server cluster;

FIG. 7 is a block diagram that illustrates one example embodiment of a primary server;

FIG. 8 is a block diagram that illustrates one example embodiment of a standby server; and

FIG. 9 is a data flow diagram that depicts the operation of a primary server in conjunction with a standby server.

### DETAILED DESCRIPTION

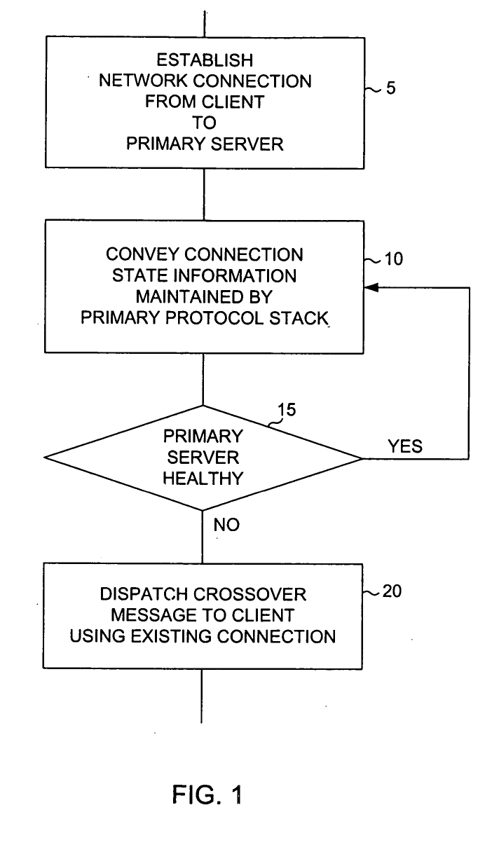

FIG. 1 is a flow diagram that depicts one example method for providing redundant connection services. According to this example method, redundant connection services are provided when a network connection is established from a client to a primary server (step 5). So long as the connection persists, state information pertaining to the connection as maintained by a primary protocol stack is conveyed (step 10). It should be appreciated that the state information pertaining to a connection, according to a variation of the present method, is conveyed to a standby server included in a high-availability server cluster. It should also be appreciated that the state information pertaining to a connection, according to yet another variation of the present method, is conveyed to an arbitrary monitoring device.

According to this example method, the health of a primary server is monitored (step 15). In the event that the primary server becomes unhealthy (step 15), or is otherwise unable to perform the role of a primary server in a high-availability server cluster, a crossover message is dispatched to the client using the existing connection (step 20). It should be noted that, according to one variation of the present method, dispatch to a client of a crossover message is accomplished by using a connection identifier associated with previously received state information pertaining to the connection.

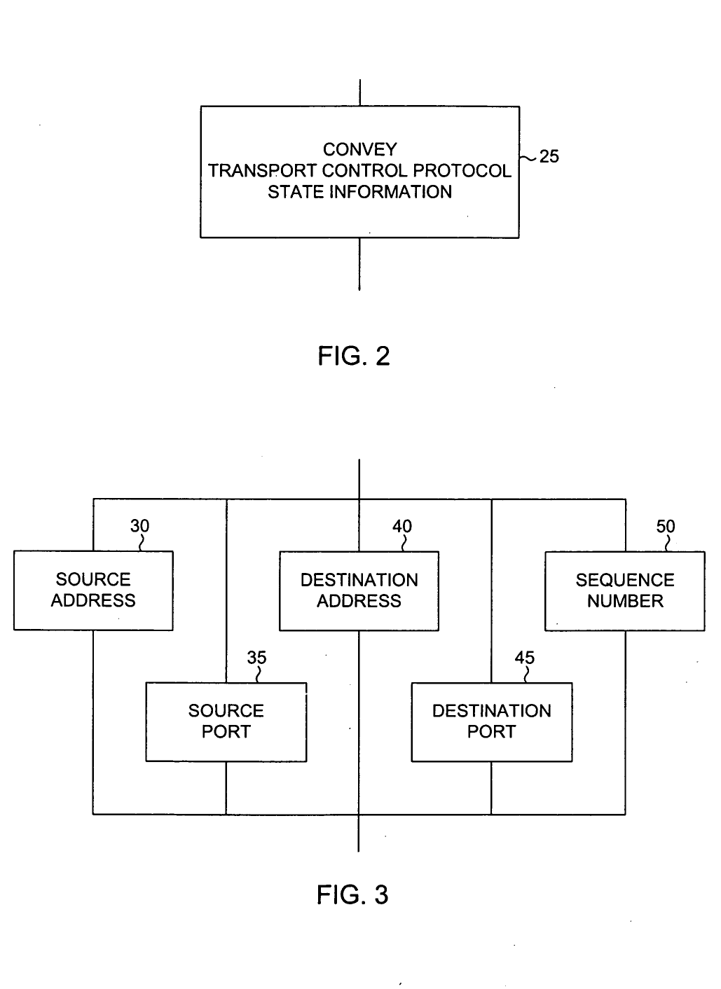

FIG. 2 is a flow diagram that depicts an alternative illustrative method for conveying connection state information. According to this alternative method, state information is conveyed by conveying state information for a connection established under the Transport Control Protocol/Internet Protocol (step 25).

FIG. 3 is a flow diagram that depicts several other alternative methods for conveying connection state information. According to one alternative example method, connection state information is conveyed by conveying a source address (step 30). According to yet another alternative example method, a source port number (step 35) is conveyed. According to yet another alternative example method, a destination address (step 40) is conveyed. In yet another alternative example method, a destination port number is conveyed (step 45). According to yet another example alternative method, a packet sequence number (step 50) is conveyed. According to one illustrative use case, the present method is applied to a connection formed in compliance with the Transport Control Protocol/Internet Protocol. According to this illustrative use case, conveyance of connection state information comprises substantially concurrent conveyance of a source address, a source port number, a destination address, a destination port number and a sequence number. Although the present description illustrates application of the present method in conjunction with the TCP/IP protocol, it should be noted that the claims appended hereto are not intended to be limited in scope to any illustrative use case presented herein for illustrative purposes.

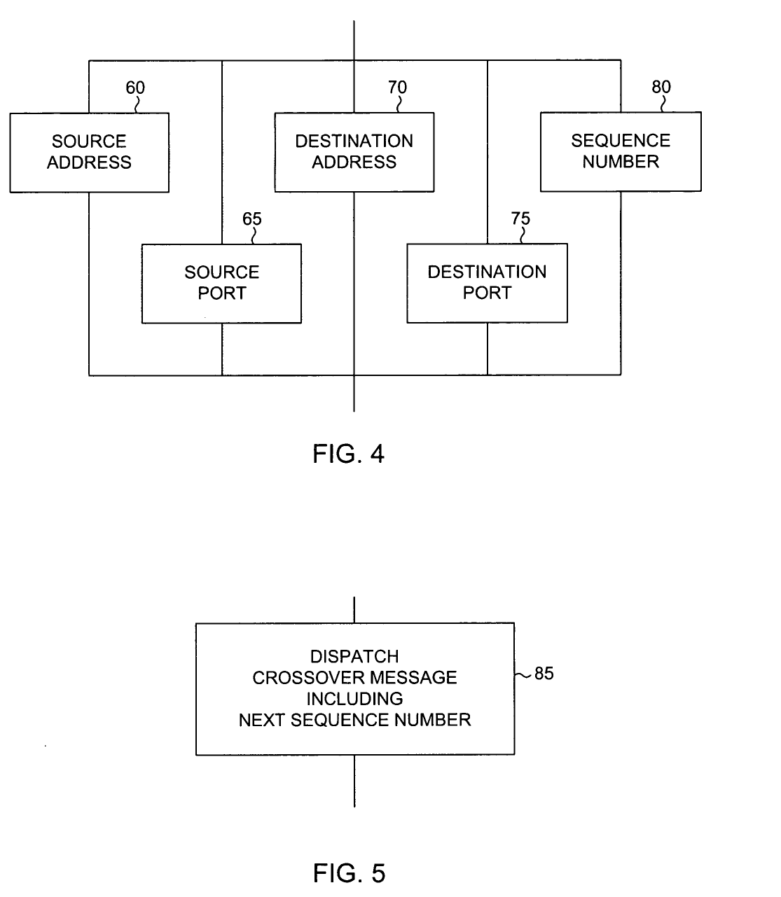

FIG. 4 is a flow diagram that depicts several illustrative example methods for dispatching a crossover message. According to one illustrative example method, a crossover message is embodied as a Transport Control Protocol reset packet. According to yet another illustrative example method, the Transport Control Protocol reset packet is dispatched to a client by addressing the reset packet according to a source address (step 60). According to yet another illustrative alternative method, the Transport Control Protocol reset packet is dispatched to a client by addressing the reset packet according to a source port number (step 65). According to yet another alternative illustrative method, the Transport Control Protocol reset packet is dispatched to a client by addressing the reset packet according to a destination address (step 70). According to yet another alternative illustrative method, the Transport Control Protocol reset packet is dispatched to a client by addressing the reset packet according to a destination port number (step 75). According to yet another alternative illustrative method, the Transport Control Protocol reset packet is formed to include a sequence number (step 80). Although this variation of the present method is directly applicable to a connection established under the TCP/IP protocol, the claims appended hereto are not intended to be limited in scope. Accordingly, the present method can be applied irrespective of the type of communications protocol used to establish a connection and the claims appended hereto are to be read in this light.

FIG. 5 is a flow diagram that illustrates one alternative method for including a sequence number in a crossover message. According to this alternative illustrative method, a sequence number included in a crossover message is set to equal the next sequence number anticipated by a client. This is accomplished by using as a basis a sequence number received as part of connection state information from a primary protocol stack. The sequence number received as part of connection state information is typically incremented to reflect the next data packet anticipated by a client. Although the description presented herein illustrates use of the present method in conjunction with the TCP/IP protocol, many other protocols include a mechanism wherein data packets included some form of sequence identifier. Accordingly, the claims appended hereto are not intended to be limited in scope or application to any particular protocol presented herein, e.g. TCP/IP, for illustrative purposes only.

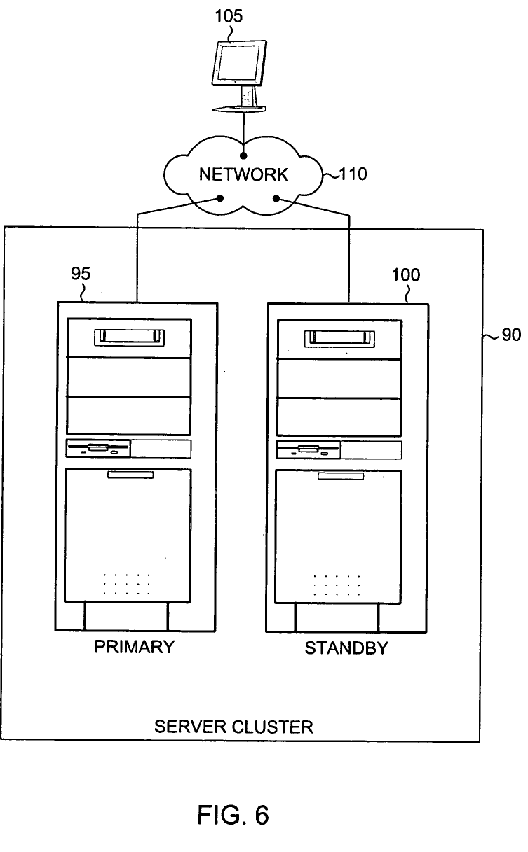

FIG. 6 is a pictorial illustration of a server cluster. The present method, according to one illustrative use case, is applied in a cluster of servers 90. In a typical server cluster 90, there is at least one primary server 95 and one or more standby servers 100. In operation, the primary server 95 performs the role of a server in a typical client-server relationship. According to this one illustrative use case, the primary server 95 and the one or more standby servers 100 connects to a network 110. Also connected to the network 110 is a client computer 105. In a typical client-server relationship, the client computer 105 uses the network 110 to establish a connection with the primary server 95. Although omitted from the figure, there are other ancillary equipments included in the server cluster, e.g. a router, which enable all of servers in the cluster to respond to a single network address. Accordingly, when the client computer 105 needs to establish a connection with the server cluster 90, the client computer 105 does not need to know the separate network addresses of each computer in the cluster 90. The client computer 105 has included therein a processor, a protocol stack and a client process. Each server in the cluster 90 also has included therein a processor, the protocol stack and a server process. In operation, the processor in the client computer 105 executes the client process. The client process typically causes the processor in the client computer 105, by means of executing the protocol stack included therein, to establish a connection with the server process executing in one of the server computers included in the server cluster 90. The processor in one of the server computers services that connection by executing a corresponding protocol stack facilitating the transfer of data between the client process and the server process. The server process is also executed by the processor in one of the server computers included in the server cluster 90.

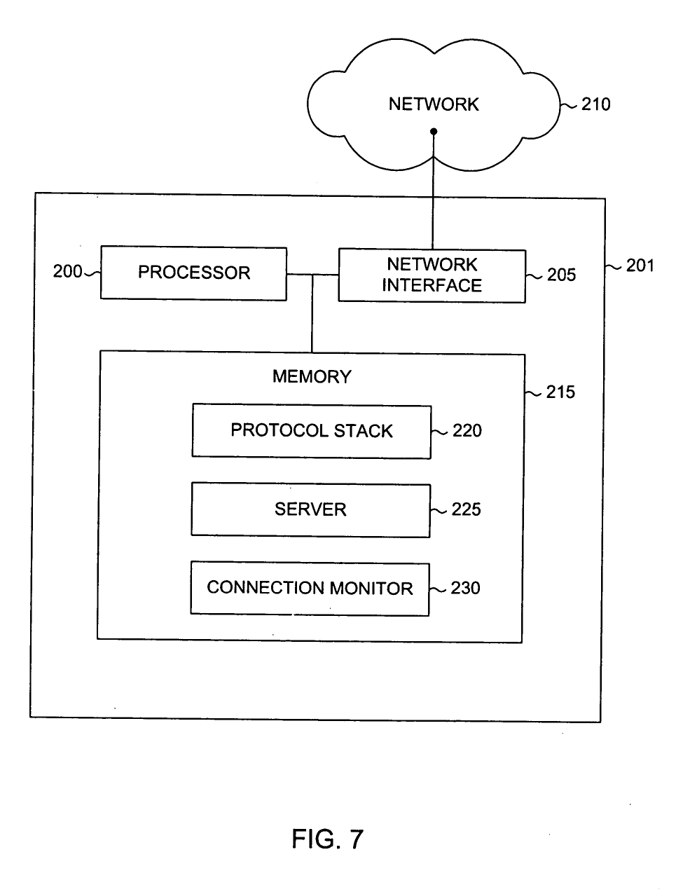

FIG. 7 is a block diagram that illustrates one example embodiment of a primary server. According to this example embodiment, a primary server 201 comprises one or more processors 200 and a network interface 205 that facilitates communication of data to and from a network 210. Also included to this example embodiment of a primary server 201 is a memory 215.

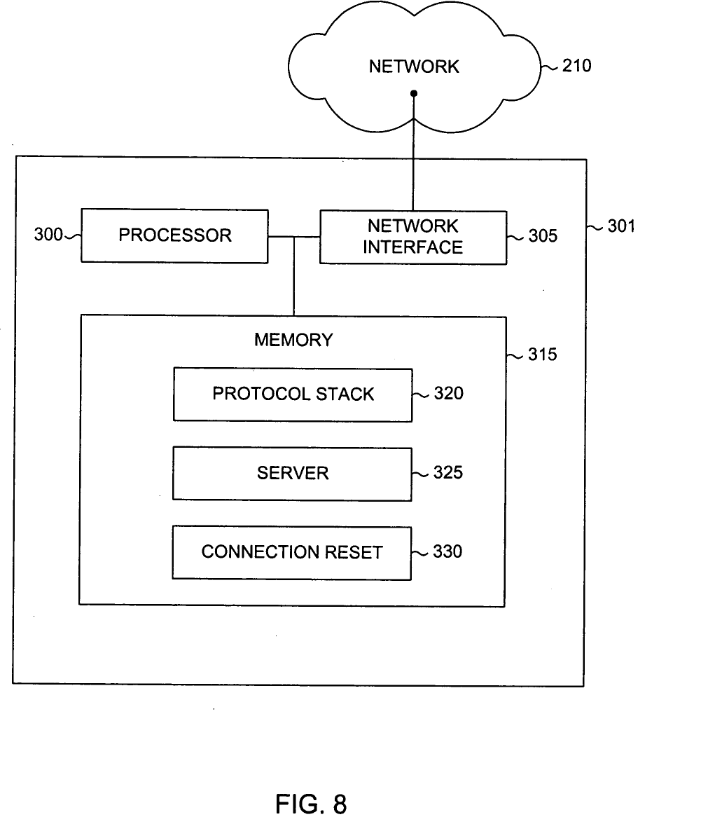

FIG. 8 is a block diagram that illustrates one example embodiment of a standby server. According to this example embodiment, a standby server 301 comprises one or more processors 300 and a network interface 305 that facilitates communication of data to and from the network 210.

The example embodiments of a primary server 201 and a standby server 301 heretofore described each further include various functional modules each of which comprises an instruction sequence that can be executed by a processor. The instruction sequence that implements a functional module, according to one alternative embodiment, is stored in the memory (215, 315) of each of the primary server 201 and a standby server 301. The reader is advised that the term “minimally causes the processor” and variants thereof is intended to serve as an open-ended enumeration of functions performed by a processor as it executes a particular functional module (i.e. instruction sequence). As such, an embodiment where a particular functional module causes a processor to perform functions in addition to those defined in the appended claims is to be included in the scope of the claims appended hereto.

FIG. 7 further illustrates that according to this example embodiment, a primary server 201 further includes a protocol stack 220, a server module 225 and a connection monitor 230.

FIG. 8 further illustrates that according to this example embodiment, a standby server 301 further includes a protocol stack 320, a server module 325 and a connection reset module 330.

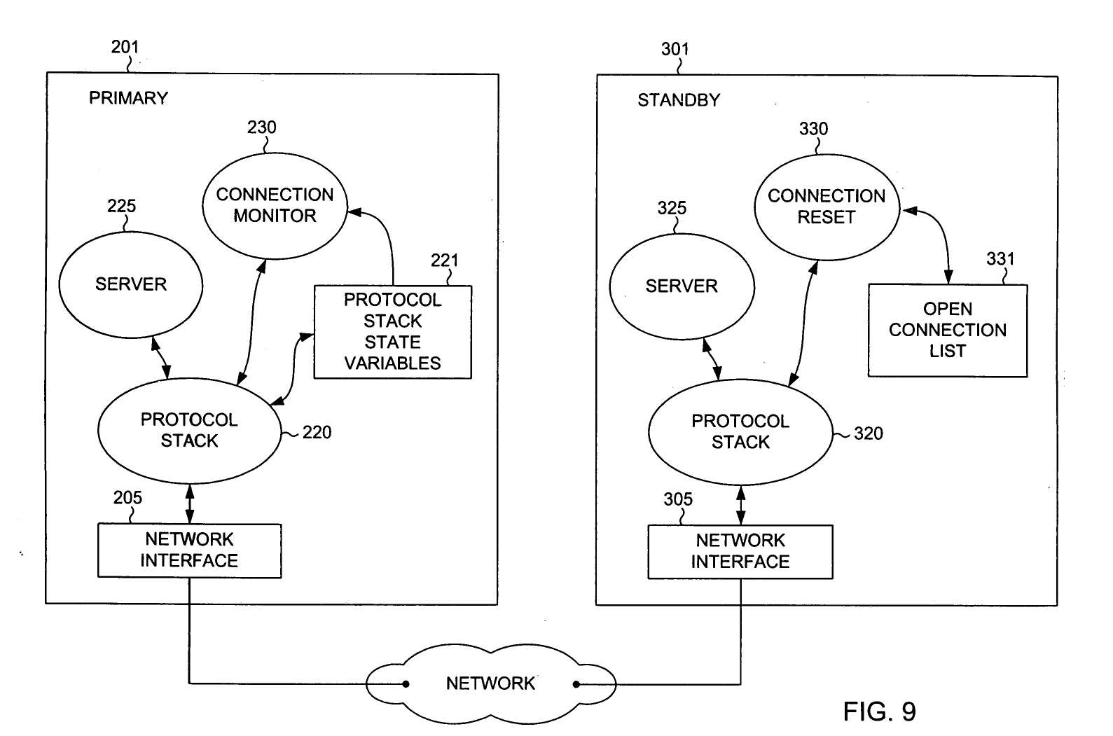

FIG. 9 is a data flow diagram that depicts the operation of a primary server in conjunction with a standby server. According to one example embodiment, the processor 200 in the primary server 201 executes the server module 225. The server module 225, when executed by the processor 200, minimally causes the processor 200 to respond to a client request (e.g. from a client request received from a network). The protocol stack 220 included in the primary server 201, when executed by the processor 200, minimally causes the processor 200 to establish a network connection with the client using the network interface 205 included in this example embodiment of the primary server 201. The connection is typically established with a client process executing in a client computer, neither of which is depicted in the figure. Typically, it is the client process that requests the establishment of a connection. The processor 200 also executes the connection monitor module 230. When executed by the processor 200, the connection monitor module 230 minimally causes the processor 200 to convey a status of the client connection. According to one alternative embodiment, the connection monitor module 230 minimally causes the processor 200 to establish an independent connection to the connection reset module 330 using the protocol stack 220. This independent connection is then used to convey information pertaining to the state of a connection to the connection reset module 330.

So long as the connection with the client is maintained, the processor 200, as it continues to execute the connection monitor module 230, monitors the state of the connection with the client process. According to one alternative embodiment, the protocol stack 220, when executed by the processor 200, minimally causes the processor 200 to store state variables that described the state of a connection in a protocol stack state variables table 221. According to one alternative embodiment, the protocol state variable table 221 is stored in the memory 215 included in this example embodiment of a primary server 201. Accordingly, the connection monitor module 230, when executed by the processor 200, further minimally causes the processor to extract information pertaining to the state of the connection from the protocol stack state variables table 221. According to one example alternative embodiment, the connection monitor module 230 minimally causes the processor to convey Transport Control Protocol state information.

According to one alternative embodiment, the connection monitor module 230, when executed by the processor 200, causes the processor to extract information that includes at least one of a source address, a source port number, a destination address and a destination port number pertaining to the connection. According to yet another alternative embodiment, the connection monitor module 230, when executed by the processor 200, causes the processor 200 to extract a sequence number pertaining to the connection. Accordingly, the connection monitor module 230 further minimally causes the processor 200 to convey at least one of the source address, the source port number, the destination address, the destination port number and a sequence number, all of which pertain to the connection. The processor 200, according to one alternative embodiment of the connection monitor module 230, is minimally caused to convey this information to a connection reset module 330 executing in a standby server 301. Conveyance of this information, according to yet another alternative embodiment, is accomplished by an independent communications connection established by the processor 200 as it continues to execute the connection monitor module 230. In furtherance of such a connection, the processor 200 executes the protocol stack 220 in order to establish a connection between the connection monitor module 230 and connection reset module 330 operating in a standby server 301. A corresponding protocol stack 320 executing in the standby server 301 minimally causes the processor 300 in the standby server 301 to support the connection with the connection reset module 330.

The processor 300 in the standby server 301, as it executes the connection reset module 330, is minimally caused to receive connection state information and to further store this connection state information in an open connection list 331. According to one alternative embodiment, the open connection list 331 is maintained in the memory 315 included in this example embodiment of a standby server 301. The open connection list 331 is used to store connection state information. According to one alternative embodiment, the connection reset module 330, when executed by the processor 300, minimally causes the processor 300 to receive as connection state information at least one of a source address, a source port number, a destination address, a destination port number and a sequence number. According to one alternative embodiment, the connection state information received in this manner is stored in the open connection list 331 in a single record for every connection that the connection reset module 330 maintains cognizance over.

According to yet another alternative embodiment, the connection reset module 330 further minimally causes the processor 300 to monitor the health of a primary server 201. This, according to one example embodiment, is accomplished by monitoring a connection established from the connection monitor module 230 executing in the primary server 201. Accordingly, the connection reset module 330 minimally causes the processor 300 to determine the health of the primary server 201 according to health messages received by way out of the connection established from the connection monitor module 230. This connection can be the same connection used to convey connection state information from the connection monitor module 230 to the connection reset module 330.

According to this example embodiment, the connection reset module 330, when executed by the processor 300 in the standby server 301, further minimally causes the processor 300 to convey a crossover message to a client when the primary server 201 is perceived as unhealthy. According to one alternative embodiment, the crossover message comprises a Transport Control Protocol reset packet that is address to the client according to at least one of a source address, a source port number, a destination address and a destination port number. Typically, the reset packet further includes a sequence number adjusted to reflect the next sequence number anticipated by the client according to information stored in the open connection list 331. It should be appreciated that where there are a plurality of open connections identified in the open connection list 331, the connection reset module 330, when executed by the processor 300, further minimally causes the processor 300 to dispatch a crossover message to one or more client processes using connections identified by state information previously received by the processor 300 and stored in the open connection list 331 as the processor 300 executes the connection reset module 330.

The functional modules (and their corresponding instruction sequences) described thus far that enable provision of redundant connection services are, according to one alternative embodiment, imparted onto computer readable medium. Examples of such medium include, but are not limited to, random access memory, read-only memory (ROM), Compact Disk (CD) ROM, Digital Versatile Disk (DVD), floppy disks, hard disk drives and magnetic tape. This computer readable medium, which alone or in combination can constitute a stand-alone product, can be used to convert at least one of a general-purpose computing into a device for rendering redundant connection services according to the techniques and teachings presented herein. Accordingly, the claims appended hereto are to include such computer readable medium imparted with such instruction sequences that enable execution of the present method and all of the teachings herein described.

While the present method and apparatus has been described in terms of several alternative and exemplary embodiments, it is contemplated that alternatives, modifications, permutations, and equivalents thereof will become apparent to those skilled in the art upon a reading of the specification and study of the drawings. It is therefore intended that the true spirit and scope of the claims appended hereto include all such alternatives, modifications, permutations, and equivalents.

1. A method for providing redundant connection services comprising:
establishing of a network connection from a client to a primary server using a primary protocol stack;
conveying connection state information maintained by the primary protocol stack;
monitoring the health of the primary server; and
dispatching to the client using the established network connection a crossover message according to the conveyed connection state information when the primary server is unhealthy.

2. The method of claim 1 wherein conveying connection state information comprises conveying transport control protocol state information.

3. The method of claim 2 wherein conveying transport control protocol state information comprises conveying at least one of a source address, a source port number, a destination address, a destination port number and a transport control protocol sequence number.

4. The method of claim 1 wherein dispatching a crossover message comprises dispatching a transport control protocol reset packet to a client addressed according to connection state information maintained by a primary protocol stack including at least one of a source address, a source port number, a destination address, a destination port number and a transport control protocol sequence number.

5. The method of claim 1 wherein dispatching a crossover message comprises dispatching a crossover message that includes a next sequence number relative to a sequence number received as part of connection state information maintained by a primary protocol stack.

6. A primary server comprising:
processor capable of executing an instruction sequence;
memory capable of storing one or more instruction sequences; network interface capable of communicating with a data network; and
one or more instruction sequences stored in the memory including:
server module that, when executed by the processor, minimally causes the processor to respond to a client request;
protocol stack module that, when executed by the processor, minimally causes the processor to establish a network connection with a client using the network interface and further minimally causes the processor to forward to the sever module a client request received over an established connection; and
connection monitor module that, when executed by the processor, minimally causes the processor to convey a status of a client connection.

7. The primary server of claim 6 wherein the connection monitor module causes the processor to convey a status of a client connection by minimally causing the processor to convey transport control protocol state information.

8. The primary server of claim 7 wherein the connection monitor module causes the processor to convey transport control protocol state information that includes at least one of a source address, a source port number, a destination address, a destination port number and a transport control protocol sequence number.

9. A standby server comprising:
processor capable of executing an instruction sequence;
memory capable of storing one or more instruction sequences;
network interface capable of communicating with a data network; and
one or more instruction sequences stored in the memory including:
server module that, when executed by the processor, minimally causes the processor to respond to a client request;
protocol stack module that, when executed by the processor, minimally causes the processor to establish a network connection with a client using the network interface and further minimally causes the processor to forward to the sever module a client request received over an established connection; and
connection reset module that, when executed by the processor, minimally causes the processor to:
receive connection state information maintained by a primary protocol stack; and
convey a cross-over message to a client using a connection identified by the received connection state information.

10. The standby server of claim 9 wherein the connection reset module causes the processor to convey a cross-over message by minimally causing the processor to convey a transport control protocol reset packet to a client addressed according to a received connection state information maintained by a primary protocol stack including at least one of a source address, a source port number, a destination address, a destination port number and a transport control protocol sequence number.

11. The standby server of claim 9 wherein the connection reset module causes the processor to convey a cross-over message by minimally causing the processor to convey a crossover message that includes a next sequence number relative to a sequence number received as part of connection state information maintained by a primary protocol stack.

12. A computer readable medium having imparted thereon one or more instruction sequences for providing redundant connection services including:
connection monitor module that, when executed by a processor, minimally causes the processor to convey a status of a client connection.

13. The computer readable medium of claim 12 wherein the connection monitor module causes a processor to convey a status of a client connection by minimally causing the processor to convey transport control protocol state information.

14. The computer readable medium of claim 13 wherein the connection monitor module causes a processor to convey transport control protocol state information that includes at least one of a source address, a source port number, a destination address, a destination port number and a transport control protocol sequence number.

15. A computer readable medium having imparted thereon one or more instruction sequences for providing redundant connection services including:
connection reset module that, when executed by a processor, minimally causes the processor to:
receive connection state information maintained by a primary protocol stack; and
convey a cross-over message to a client using a connection identified by the received connection state information.

16. The computer readable medium of claim 15 wherein the connection reset module causes a processor to convey a cross-over message by minimally causing the processor to convey a transport control protocol reset packet to a client addressed according to a received connection state information maintained by a primary protocol stack including at least one of a source address, a source port number, a destination address, a destination port number and a transport control protocol sequence number.

17. The standby server of claim 15 wherein the connection reset module causes the processor to convey a cross-over message by minimally causing the processor to convey a crossover message that includes a next sequence number relative to a sequence number received as part of connection state information maintained by a primary protocol stack.

18. An apparatus for providing a redundant connection service comprising:
means for establishing a connection with a client;
means for conveying the state of the connection; and
means for dispatching a crossover message to the client when the means for establishing the connection becomes unhealthy.

19. The apparatus of claim 18 wherein the means for conveying the state of a connection comprises a means for conveying at least one of a source address, a source port number, a destination address, a destination port number and a transport control protocol sequence number.

20. The apparatus of claim 18 wherein the means for dispatching a crossover message comprises:
means for dispatching a crossover message that is addressed according to information pertaining to the state of the connection including at least one of a source address, a source port number, destination address, destination port number and transport control protocol sequence number.
